(19) United States
(12) Patent Application Publication
(10) Pub. No.: US 2009/0151110 A1
(43) Pub. Date: Jun. 18, 2009

(54) Adaptor Assemblies for Connecting Wiper Blades to Wiper Arms

(76) Inventor: Shu-Lan KU, Taipei (TW)

Correspondence Address: HARNESS, DICKEY & PIERCE, P.L.C., P.O. BOX 828, BLOOMFIELD HILLS, MI, 48303, US

(21) Appl. No.: 12/250,073

(22) Filed: Oct. 13, 2008

Related U.S. Application Data
(63) Continuation-in-part of application No. 11/498,960, filed on Aug. 4, 2006.

(51) Int. Cl. B60S 1/40

(52) U.S. Cl. 15/250.32

(57) ABSTRACT

An adaptor assembly kit for connecting a wiper arm to a wiper blade includes a housing that is removably mounted to the wiper blade, and a plurality of uniquely structured adapting members. The adapting members are removably and interchangeably mounted to the housing and engage a wiper arm. Depending on a structure of the wiper arm, an adapting member designed to accommodate the structure of the wiper arm is selected from the plurality of adapting members, is mounted to the housing, and is coupled to the wiper arm.

### RELATED APPLICATION

This application is a continuation-in-part of U.S. patent application Ser. No. 11/498,960, filed on Aug. 4, 2006 and entitled “Windshield Wiper Bridge Base Assembly,” the disclosure of which is incorporated herein by reference in its entirety.

### BACKGROUND

Wiper arms for different car models generally have different configurations. The front ends of the wiper arms may include a hook, a pin, a flat plate, or a U-shaped housing, etc. for engaging a wiper blade. The wiper blade may include a connecting device that is adapted for only a specific type of wiper arm. Due to the different configurations of the wiper arms and the connecting devices, it generally requires a huge stock of different connecting devices for the different wiper arms. Moreover, mounting current commercial connecting devices to the wiper blades in the marketplace is time consuming.

### SUMMARY

Accordingly, an adaptor assembly kit for connecting a wiper arm to a wiper blade includes a housing that is removably mounted to the wiper blade, and a plurality of uniquely structured adapting members. The adapting members are removably and interchangeably mounted to the housing and engage a wiper arm. Depending on a structure of the wiper arm, an adapting member designed to accommodate the structure of the wiper arm is selected from the plurality of adapting members, is mounted to the housing, and is coupled to the wiper arm.

In other features, a wiper blade assembly includes a support element, a rubber strip attached to the support element, a bridge base secured to the support element, a housing removably mounted to the bridge base in a snap-on relationship, and a plurality of interchangeable adapting members removably mounted to the housing. Each of the adapting members has a different structure for engaging wiper arms of different configurations.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of a wiper blade and a bridge base in accordance with the teachings of the present disclosure;

FIG. 2 is a perspective view of the bridge base of FIG. 1;

FIG. 3 is a cross-sectional view of an assembled wiper blade and the bridge base;

FIG. 4 is a perspective view of a wiper blade assembly in accordance with the first embodiment of the present disclosure;

FIG. 5 a perspective view of a wiper arm of the wiper blade assembly of the first embodiment;

FIG. 6 is a perspective view of an adaptor assembly of the first embodiment, showing the adaptor assembly in a closed position;

FIG. 7 is a perspective view of an adaptor assembly of the first embodiment, showing the adaptor assembly in an open position;

FIG. 8 is a perspective view of an adaptor assembly of the first embodiment, wherein the cover is removed for clarity;

FIG. 9 is a top perspective view of an adapting member of an adaptor assembly of the first embodiment;

FIG. 10 is a bottom perspective view of an adapting member of an adaptor assembly of the first embodiment;

FIG. 11 is a perspective view of a lower housing of an adaptor assembly of the first embodiment;

FIG. 12 is a perspective view of a cover of an adaptor assembly of the first embodiment;

FIG. 13 is a perspective view of a wiper arm and an adaptor assembly of the first embodiment, showing the cover in an open position;

FIG. 14 is a bottom perspective view of a wiper blade assembly in accordance with a first embodiment of the present disclosure;

FIG. 15 is an enlarged view of portion A of FIG. 14;

FIG. 16 is a perspective view of a wiper blade assembly in accordance with a second embodiment of the present disclosure;

FIG. 17 is a perspective view of a wiper arm of a wiper blade assembly of the second embodiment;

FIG. 18 is a perspective view of an adaptor assembly of the second embodiment;

FIG. 19 is perspective view of an adapting member of an adaptor assembly of the second embodiment;

FIG. 20 is another perspective view of an adapting member of an adaptor assembly of the second embodiment;

FIG. 21 is a bottom perspective view of an adapting member of an adaptor assembly of the second embodiment;

FIG. 22 is an enlarged view of portion B of the adapting member of FIG. 20;

FIG. 23 is a cut-away view showing the engagement between an adapting member and the wiper arm of the second embodiment;

FIG. 24 is a view showing the engagement between the wiper arm and the adapting member of the second embodiment;

FIG. 25 is a perspective view of an adaptor assembly in accordance with a third embodiment of the present disclosure;

FIG. 26 is a perspective view of a wiper arm used in the third embodiment;

FIG. 27 is a top view of an adapting member of the third embodiment;

FIG. 28 is a cross-sectional view of the adapting member of the third embodiment, taken along line A-A of FIG. 27;

FIG. 29 is a view illustrating steps of assembling a wiper arm to a wiper blade using an adaptor assembly of the third embodiment;

FIG. 30 is a top perspective view of a lower housing of the fourth embodiment;

FIG. 31 is bottom perspective view of a lower housing of the fourth embodiment;

FIG. 32 is an exploded view of an adaptor assembly in accordance with a fifth embodiment of the present disclosure;

FIG. 33 is a perspective view of a lower housing in accordance with a sixth embodiment of the present disclosure;

FIG. 34 is a side view of a lower housing of the sixth embodiment;

FIG. 35 is a front view of a lower housing of the sixth embodiment;

FIG. 36 is an enlarged view of portion A of FIG. 35;

FIG. 37 is a view showing steps of mounting an adapting member to a lower housing of the sixth embodiment;

FIG. 38 is a view showing different shapes of a slot of a lower housing of the sixth embodiment;

FIG. 39 is a cross-sectional view of an adapting member in accordance with a seventh embodiment of the present disclosure;

FIG. 40 is a perspective view of a wiper blade assembly in accordance with an eighth embodiment of the present disclosure; and

FIG. 41 shows a plurality of adaptors that include a sound-verification feature;

FIG. 42 shows steps of assembling an adaptor to a wiper blade frame to generate an audible sound;

FIG. 43 is a perspective view of wiper blade components that incorporate a sound-verification feature; and

FIG. 44 is a schematic cross-sectional view of an adaptor and a housing.

### DETAILED DESCRIPTION

The following description is merely exemplary in nature and is not intended to limit the present disclosure, application, or uses. It should be understood that throughout the drawings, corresponding reference numerals indicate like or corresponding parts and features.

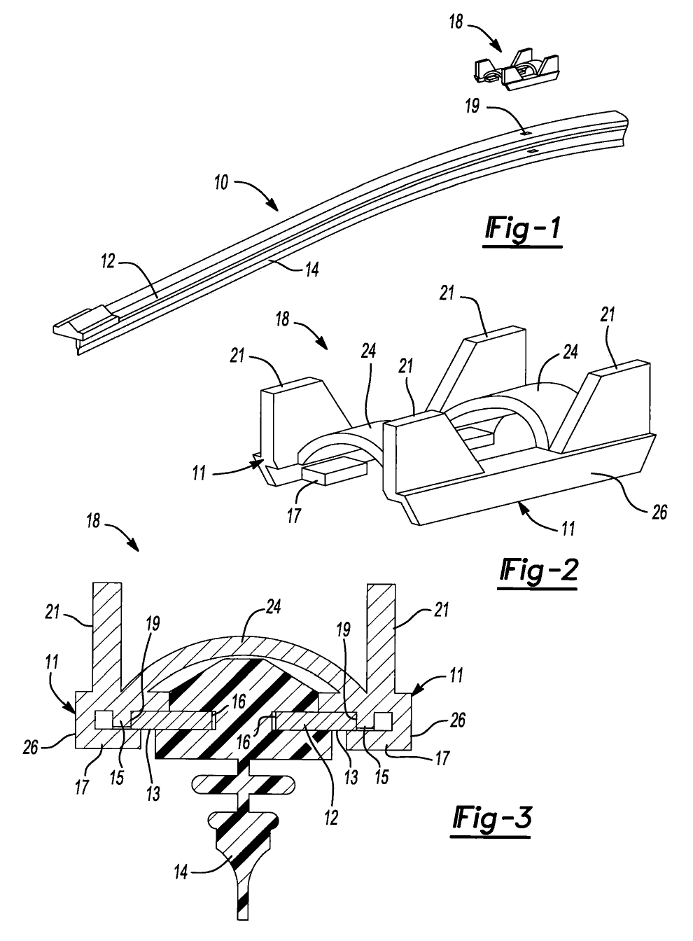

Referring to FIGS. 1 to 3, a wiper blade 10 includes an elongated metal support element 12 and a rubber strip 14 attached to the metal support element 12. The metal support element 12 has a one-piece metal structure and defines a longitudinal slot 16 (FIG. 3). The rubber strip 14 is inserted in the longitudinal slot 16 and is attached to the support element 12. A bridge base 18 is secured to the wiper blade 10 as a unit. The bridge base 18 includes side rails 11 disposed on longitudinal edges of the support element 12. The side rails 11 each include a positioning part 15 and a securing part 17. The positioning parts 15 extend downwardly from the side rails 11 and are inserted into a corresponding one of positioning holes 19 of the support element 12. The securing parts 17 abut against a bottom surface 13 of the support element 12. The side rails 11 include side surfaces 26. Four extension arms 21 extend upwardly from the side rails 11. The side rails 11 are connected by curved cross members 24.

### First Embodiment

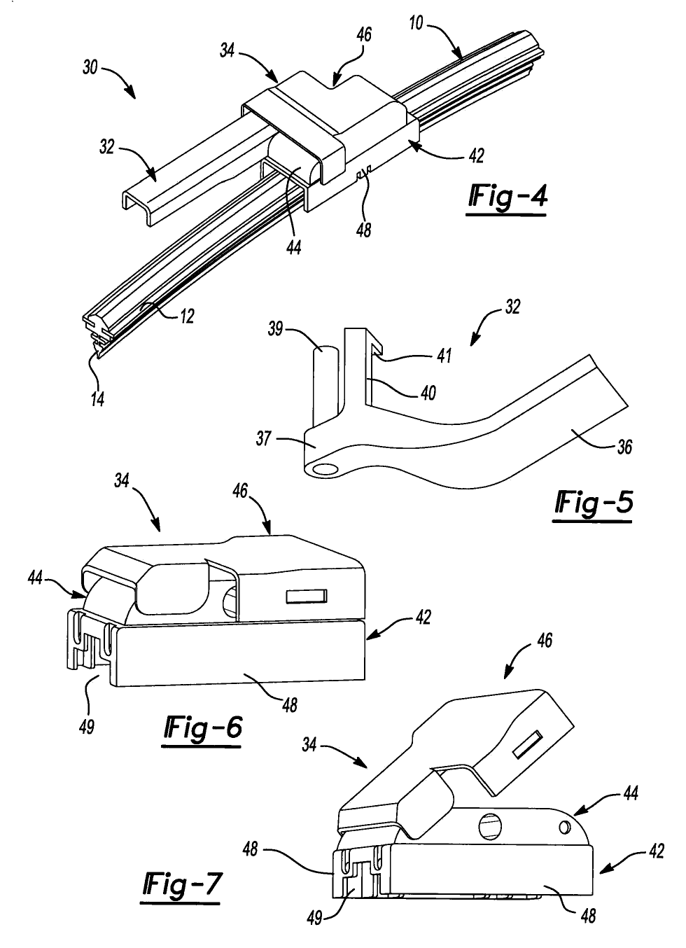

Referring to FIG. 4, a wiper blade assembly 30 in accordance with a first embodiment of the present disclosure includes the wiper blade 10, a wiper arm 32, and an adaptor assembly 34 that connects the wiper arm 32 to the wiper blade 10. Only a portion of the wiper arm 32 is shown in the drawings. As shown in FIG. 5, the wiper arm 32 includes an elongated arm portion 36 and a front end 37. A circular pin 39 and an L-shape flat pin 40 extend laterally from the front end 37 of the wiper arm 32. The L-shape flat pin 40 includes a bent portion 41 at its free end.

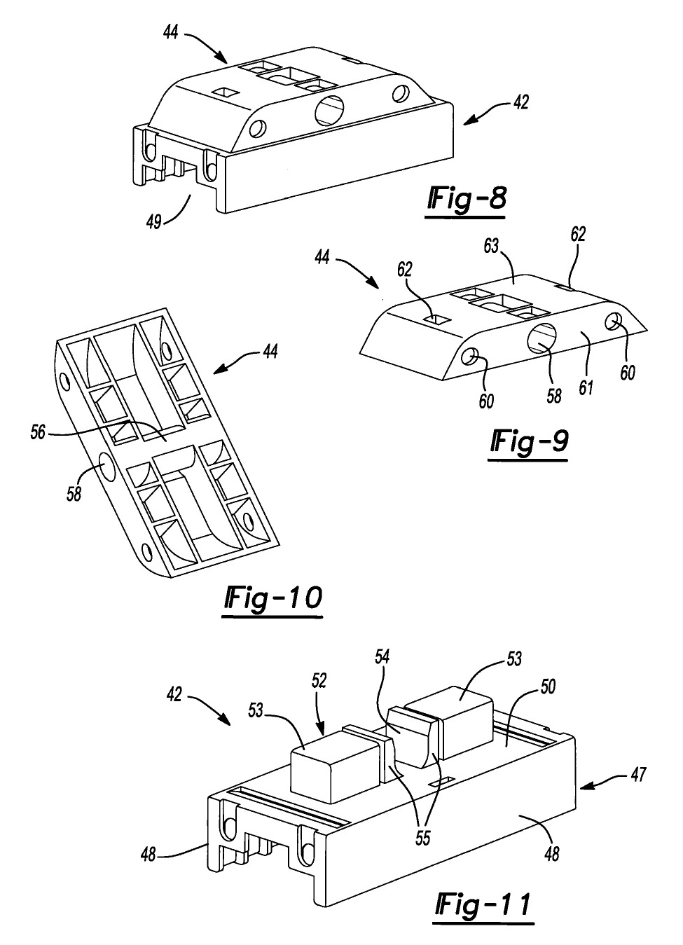

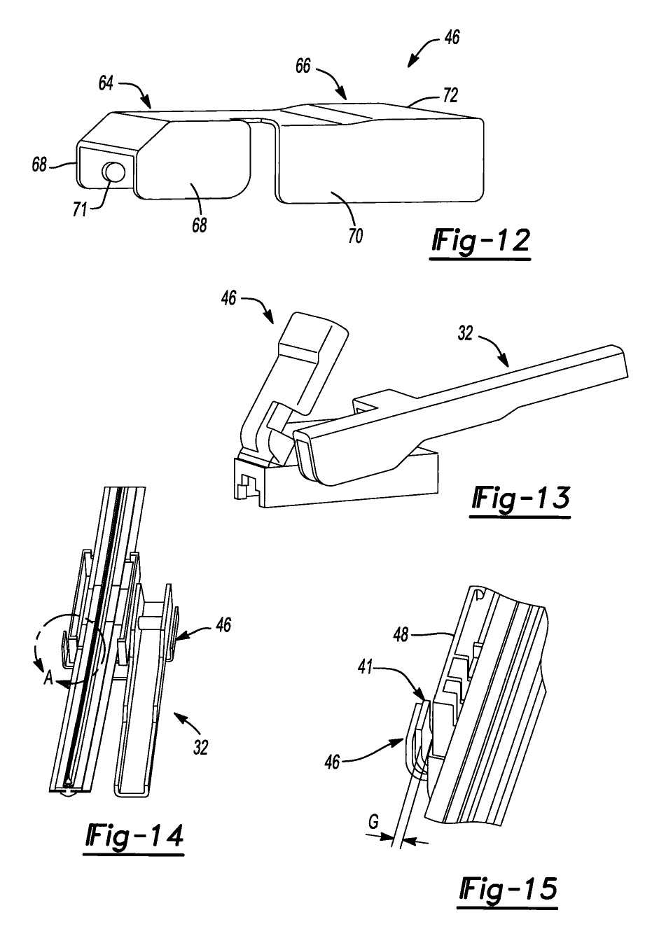

As shown in FIGS. 6 to 12, the adaptor assembly 34 includes three components: a lower housing 42, an adapting member 44 and a cover 46. The lower housing 42 has a U-shaped base 47 and a flange 52 extending perpendicularly from the U-shaped base 47 (FIG. 11). The U-shaped base 47 includes two side walls 48 and a top wall 50 connecting and disposed between the side walls 48. The lower housing 42 is mounted on the bridge base 18 in a snap-on relationship. As such, the side walls 48 of the lower housing 42 engage the side surfaces 26 of the bridge base 18. The bridge base 18 is received in the receiving space 49 of the U-shaped lower housing 42. The flange 52 includes a pair of extensions 53. A slot 54 is formed between the extensions 53. A pair of deflectable arms 55 are provided in the slot 54 to improve engagement between a tubular structure 56 of the adapting member 44 and the flange 52 of the lower housing 42.

The adapting member 44 has a substantially planar top surface 63 and a tubular structure 56 extending transversely of the longitudinal direction of the wiper blade 10. The adapting member 44 is mounted to the lower housing 42 through engagement between the tubular structure 56 and the slot 54. The tubular structure 56 has a hole 58 for receiving the circular pin 39 of the wiper arm 32. A pair of pin holes 60 are formed at side surfaces 61 at each longitudinal end of the adapting member 44. A pair of locking recess 62 are formed on the top surface 63.

The cover 46 has a front end 64 and a rear end 66. The front end 64 has a U-shaped structure defining two side walls 68. A protrusion 71 is formed at the inner surface of each side wall 68. The front end 64 of the upper cover 46 is pivotably mounted to the adapting member 44 through engagement between the protrusions 71 of the cover 46 and the locking recesses 62 of the adapting member 44.

The rear end 66 also has a U-shaped structure defining two side walls 70. The rear end 66 is wider than the front end 64. The rear end 66 includes a protrusion 72 extending downwardly from the top surface for engaging an adjacent one of the locking recess 62 on the top surface 63 of the adapting member 44.

When the cover 46 is in the closed position as shown in FIG. 6, the flat surface 63 of the adapting member 44 and the cover 46 defines a space therebetween for receiving the L-shaped pin 40 of the wiper arm 32. When assembled, the wiper arm 32 and the wiper blade 10 are disposed side by side. The wiper arm 32 is disposed adjacent to one of the side surfaces 61 of the adapting member 44 and one of the side walls 48 of the lower housing 42. The L-shape flat pin 40 and the circular pin 39 extending transversely of the wiper blade 10. The bent end 41 is disposed adjacent to the other one of the side surfaces 61 of the adapting member 44 and the other one of the side walls 48 of the lower housing 42.

Referring to FIG. 13, to assemble the wiper arm 32 to the wiper blade 10, the adaptor assembly 34 is mounted on the bridge base 18 in a snap-on relationship. Next, the cover 46 of the adaptor assembly 34 is pivoted to expose the adapting member 44. The wiper arm 32 is then assembled to the adaptor assembly 34 by inserting the circular pin 39 of the wiper arm 32 into the hole 58 of the adapting member 44 at an angle relative to the adapting member 44.

As shown in FIGS. 14 and 15, after the circular pin 39 is inserted, the wiper arm 32 is pivoted so that the L-shaped flat pin 40 contacts the top surface 63 of the adapting member 44 with the bent end 41 of the L-shaped flat pin 40 disposed adjacent to the side surface 61 of the adapting member 44 and the side wall 48 of the lower housing 42 distal of the arm portion 36 of the wiper arm 32. The bent end 41 is spaced apart from the side surface 61 of the adapting member 44 and the side wall 48 of the lower housing 42 by a gap G.

After the wiper arm 32 is in place, the cover 46 is pivoted toward the top surface 63 of the adapting member 44 to cover the L-shaped flat pin 40. The cover 46 is locked on the adapting member 44 through the engagement between the protrusion 72 of the cover 46 and the recess 62 of the adapting member 44.

It is understood and appreciated that the cover 46 may be locked on the adapting member 44 by other means. For example, the cover 46 may be locked to the adapting member 44 by friction engagement between the side wall 68 of the cover 46 and the side surface 61 of the adapting member 44. Alternatively, the protrusion 72 may be formed at the side wall 68 of the cover 46 and the recess 62 may be formed at the side surface 61 of the adapting member 44

### Second Embodiment

Referring to FIG. 16, a wiper blade assembly 80 in accordance with a second embodiment of the present disclosure includes a wiper blade 10, a bridge base 18, a wiper arm 82, and an adaptor assembly 84 for connecting the wiper arm 82 to the bridge base 18. Only a portion of the wiper arm 82 is shown in the drawings. As shown in FIG. 17, the wiper arm 82 includes a U-shaped housing 85 having a top surface 86, a pair of side walls 88 and a protrusion 90 at a front edge.

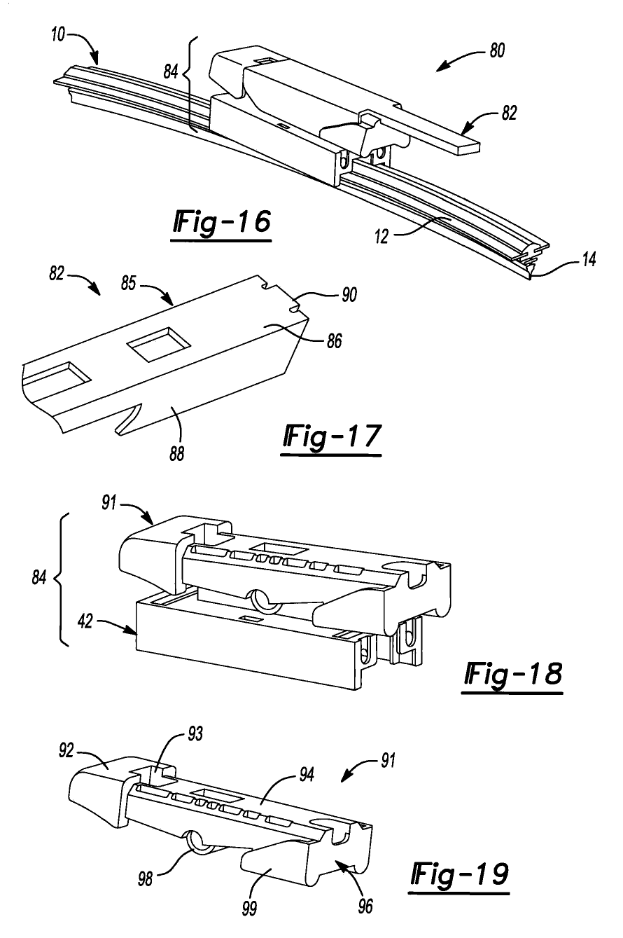

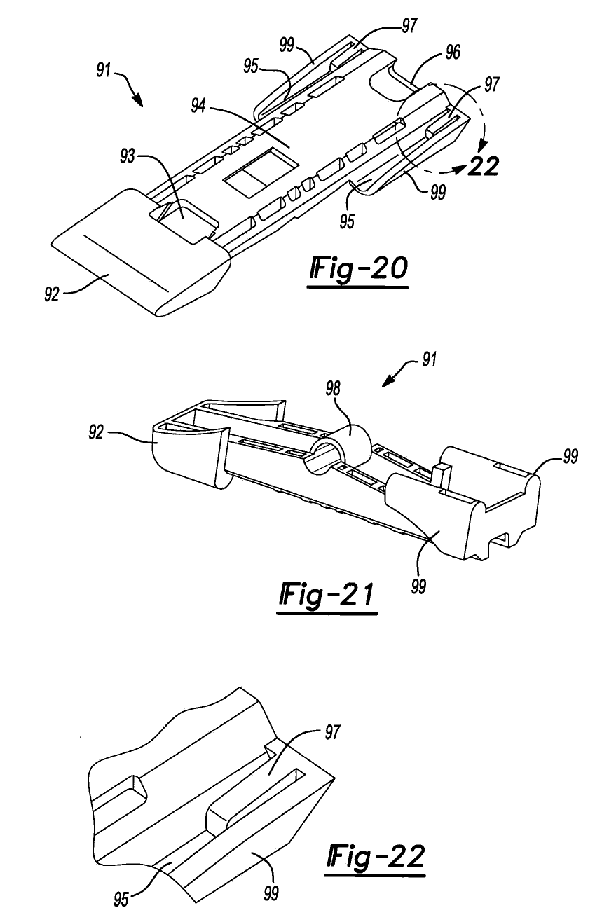

Referring to FIGS. 18 through 22, the adaptor assembly 84 has two components: a lower housing 42 and an adapting member 91 pivotably mounted on the lower housing 42. The lower housing 42 of the second embodiment is the same as that described in the first embodiment and is mounted on the bridge base 18 in the same manner as described in the first embodiment. The adapting member 91 engages the wiper arm 82 to secure the wiper arm 82 to the wiper blade 10.

The adapting member 91 includes a front end 92, a main body 94 and a rear end 96. A recess 93 is formed between the front end 92 and the main body 94. A pin 98 is formed at a bottom side of the main body 94. The rear end 96 includes two side ear portions 99 each defining a slot 95. A deflectable finger 97 in the form of a cantilever beam extends from the ear portion 99 and is disposed in the slot 95.

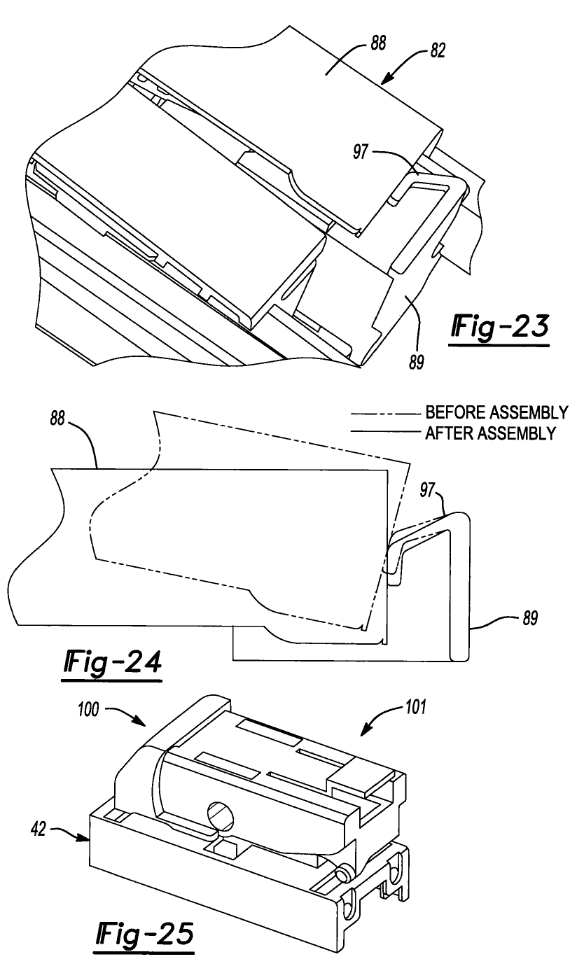

Referring to FIGS. 23 and 24, to assemble the wiper arm 82 to the wiper blade 10, the adaptor assembly 84 is mounted to the bridge base 18 in a snap-on relationship. The wiper arm 82 is attached to the adaptor assembly 84 by first inserting the protrusion 90 of the wiper arm 82 into the recess 93 of the adaptor assembly 84 at an angle relative to the adaptor assembly 84. The wiper arm 82 is then pivoted down around the protrusion 90 so that the side walls 88 of the wiper arm 82 can be received in the slots 95 of the adapting member 91. As the wiper arm 82 is pivoted down, the side walls 88 of the wiper arm 82 push the deflectable fingers 97 against a rear wall 89 from which the deflectable fingers 97 extend. When the side walls 88 of the wiper arm 82 are completely received in the slots 95, the biasing force F of the deflectable fingers 97 pushes the side walls 88 of the wiper arm 82 against the front end 92 of the adapting member 91. As such, the wiper arm 82 is secured and located between the front end 92 and the deflectable fingers 97.

### Third Embodiment

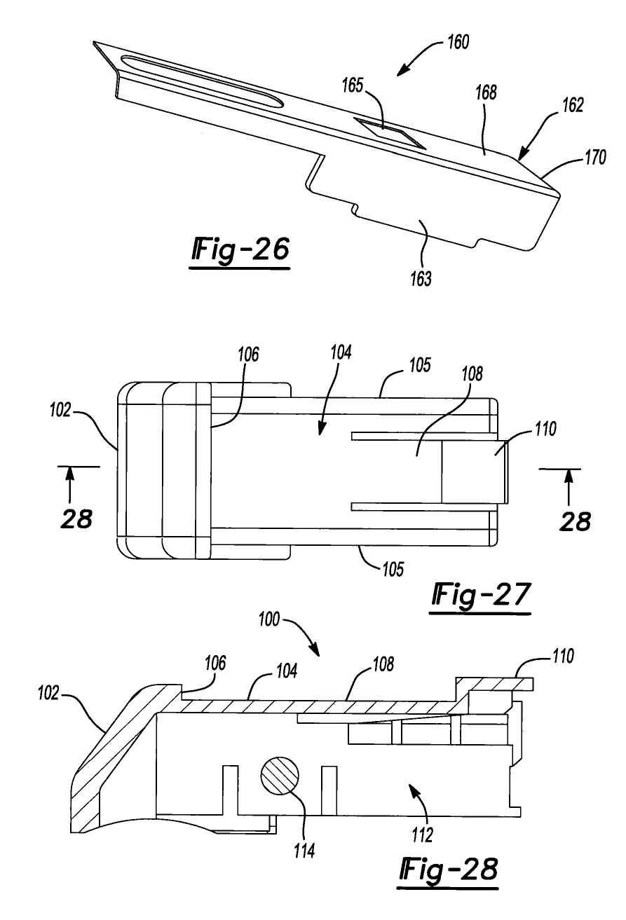

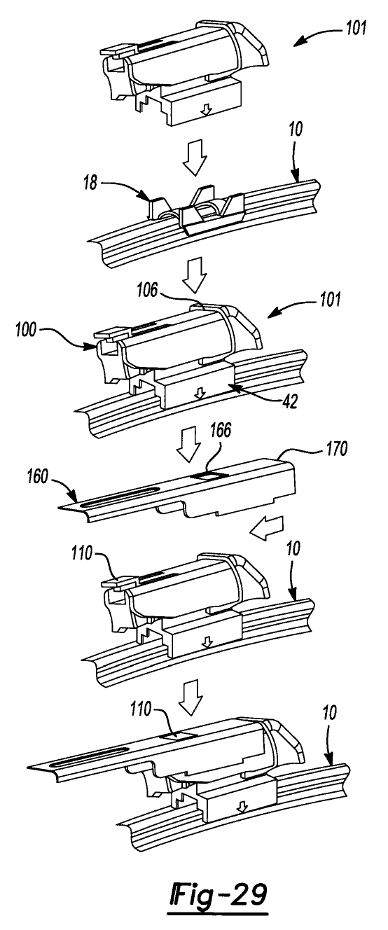

Referring to FIGS. 25 to 28, an adaptor assembly 101 in accordance with a third embodiment of the present disclosure includes a lower housing 42 and an adapting member 100 pivotably mounted on the lower housing 42. The lower housing 42 is the same as those described in the first and the second embodiments and is mounted to a bridge base 18 in the same manner as previously described. As shown in FIG. 26, a wiper arm 160 suitable for the adaptor assembly 101 includes a U-shaped housing 162, a pair of side walls 163, an opening 165 on a top surface 168, and a front flat edge 170.

The adapting member 100 includes a front end 102 and main body 104. A shoulder 106 is defined between the front end 102 and the main body 104. The main body 104 has a substantially U-shaped configuration and includes two side walls 105 and a U-shaped receiving space 112. A deflectable arm 108 is formed on the top surface of the main body 104. A protrusion 110 is formed on a free end of the deflectable arm 108. A pivot pin 114 is formed transversely in the U-shaped receiving space 112 and can be inserted into the slot 54 of the lower housing 42 so that the adapting member 100 is pivotably mounted on the lower housing 42 through the engagement between the pivot pin 114 and the slot 54.

Referring to FIG. 29, to assemble the wiper arm 160 to the adaptor assembly 101 of the third embodiment, the front edge 170 of the wiper arm 160 engages the shoulder 106 of the adapting member 100. The main body 104 of the adapting member 100 is received in the hollow space defined by the U-shaped housing 162 of the wiper arm 160. When the wiper arm 160 is positioned in place, the protrusion 110 on the deflectable arm 108 is inserted into the opening 165 of the wiper arm 160 to secure the wiper arm 160 to the adaptor assembly.

### Fourth Embodiment

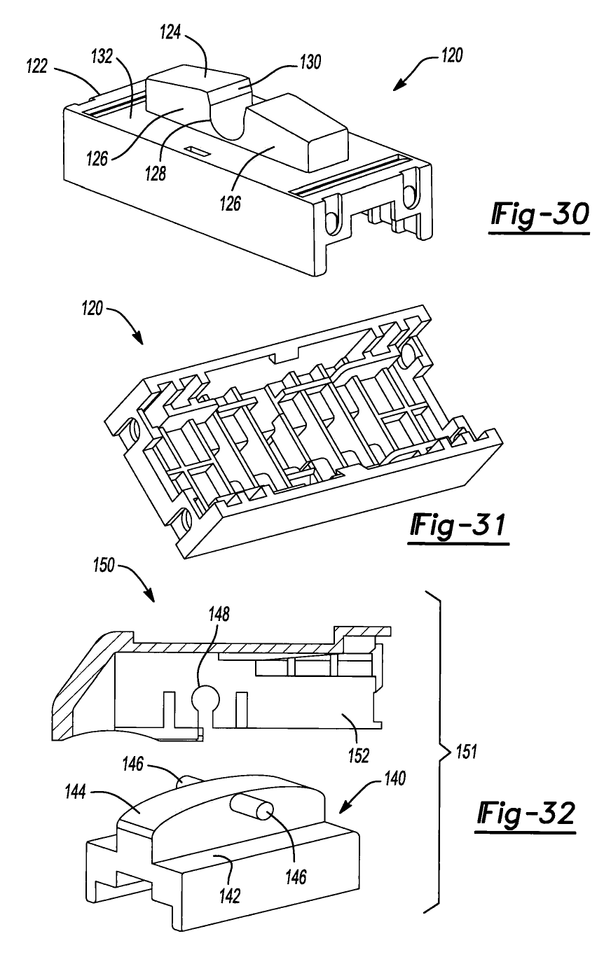

Referring to FIGS. 30 and 31, a modified lower housing 120 of the fourth embodiment includes a U-shaped portion 122 and a flange 124 on the U-shaped portion 122. The lower housing 120 is similar to the lower housing 42 of the first to third embodiment, differing in the flange 124. The flange 124 has a tapered structure and includes two thinner portions 126 at longitudinal ends and a thicker portion 128 in the middle portion. A pin-receiving slot 130 is formed in the thicker portion 128. With this design, the pin-receiving slot 130 is spaced from the top surface 132 of the U-shaped portion 122 by a larger distance. Therefore, the modified lower housing 120 allows the adapting members 91, 100 of the second and third embodiments to have a higher degree of pivoting motion. The lower housing 120 of the present embodiment can be used with the adapting member 44 of the first embodiment.

### Fifth Embodiment

Referring to FIG. 32, an adaptor assembly 151 of the fifth embodiment includes a lower housing 140 and an adapting member 150. The adaptor assembly 151 of this embodiment is similar to that of the adaptor assembly of the third embodiment, differing in the position of the pin and the slot. In this embodiment, the pin is provided at the lower housing 140 and the slot for receiving the pin is formed at the adapting member 150.

More specifically, the lower housing 140 of the present embodiment includes a U-shaped portion 142 and a flange 144. A pair of pivot pins 146 extend laterally from the flange 144 in opposite directions. The adapting member 150 includes a recess 148 formed on each of the side walls 152 for receiving a pair of pivot pins 146 of the lower housing 140.

### Sixth Embodiment

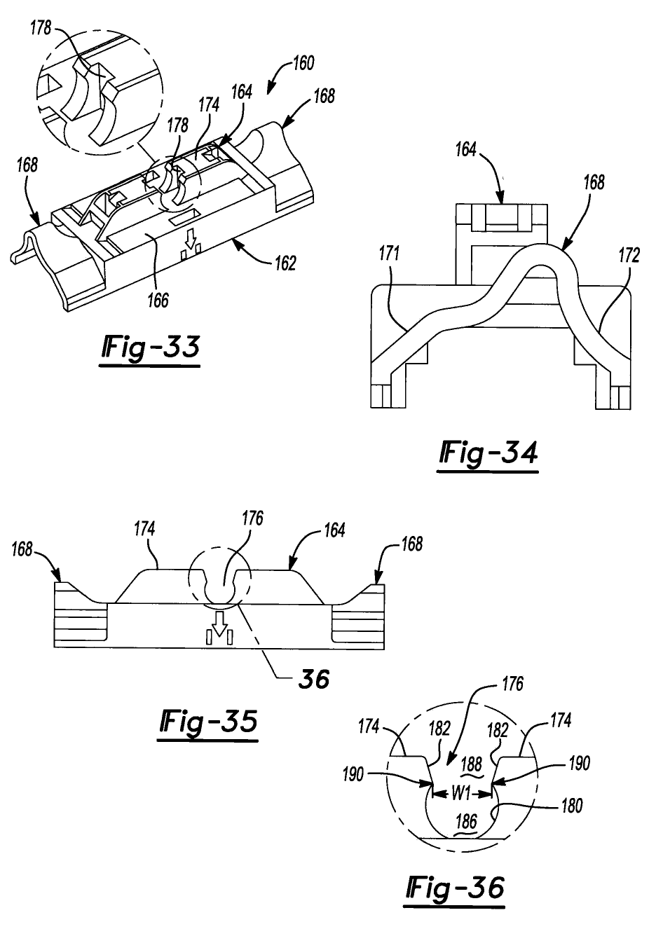

Referring to FIGS. 33 to 35, a lower housing 160 of the sixth embodiment may be used with any of the adapting members 44, 91, 100 previously described in the first to third embodiments. The lower housing 160 is similar to the lower housing previously described except that the lower housing 160 includes protective covers for spoilers, a sound-verification feature, and a positioning feature. The lower housing 160 includes a U-shaped base 162, a flange 164 extending upwardly from a top surface 166 of the U-shaped base 162, and a pair of protective covers 168 provided at longitudinal ends of the U-shaped base 162.

The protective covers 168 have a profile conforming to a cross-sectional profile of spoilers (not shown) mounted between longitudinal ends of the support element and the longitudinal ends of the lower housing 160. The spoilers are generally mounted to the support element for deflecting wind to reduce wind resistance during wiping. The protective covers 168 have a triangle-like shape, each having a first side 171 to be disposed adjacent to a wind deflection surface of the spoilers and a second side 172 opposite to the first side 171. When the lower housing 160 is mounted on the bridge base, a portion of the spoilers is received in the protective covers 168. As such, the protective covers 168 prevent dust or foreign substances from entering the gaps that may be formed between an adaptor assembly and the spoilers if the protective covers are not provided. In addition, the protective covers 158 may further secure the spoilers to the support element.

The flange 164 includes a sound verification feature. The flange 164 has an upper surface 174 and a slot 176 extending from the upper surface 174 to the upper surface 166 of the U-shape base 162. The upper surface 174 of the flange 164 has a recess 178 at one side of the slot 176.

As shown in FIG. 36, the slot 176 has a circular surface 180 adjacent to the U-shape base 162 and two chamfered surfaces 182 that connect the circular surface 180 to the upper surface 174 of the flange 164. The circular surface 180 defines a circular opening 186. The chamfered surfaces 182 define a widening opening 188 having a trapezoid shape. A narrowed portion 190 is formed at the junction of the chamfered surfaces 182 and the circular surface 180. The narrowed portion 190 defines a narrowed passage 191 that has a width W1. The circular opening 186 is an enlarged opening compared with the narrowed passage 191.

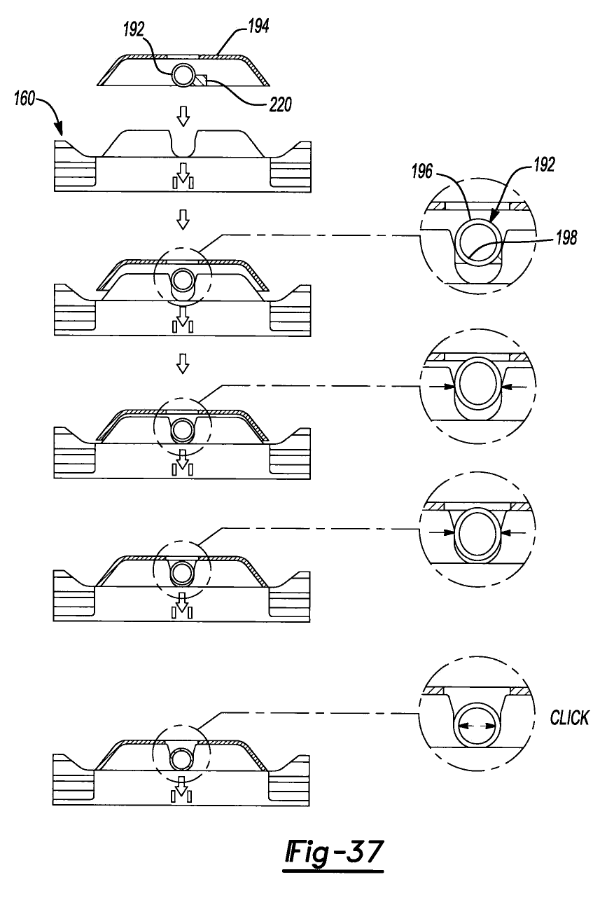

As shown in FIG. 37, a tubular pin 192 of an adapting member 194 can be easily inserted into the widening opening 188 of the slot 176. The adapting member 194 is shown for illustrative purposes and may have a structure similar to any of those in the embodiments previously described.

The tubular pin 192 has a thin wall 196 and a hollow space 198 surrounded by the thin wall 196. The tubular pin 192 has an outside diameter slightly smaller than the inside diameter of the circular opening 186 and larger than the width W1 of the narrowed passage 191.

As the tubular pin 192 passes through the narrowed passage 191 that is smaller than the outside diameter of the tubular pin 192, the tubular pin 192 can be compressed and deformed by the narrowed portion 190 due to its thin-walled structure. When the tubular pin 192 is received in the circular opening 184 (i.e., an enlarged opening), the compressed and deformed tubular pin 192 quickly return to its original, non-compressed, non-deformed position due to its own flexibility. The quick expansion of the tubular pin results in the tubular pin clashing against the circular surface 180 to generate an audible sound, for example, a click sound.

The enlarged opening does not have to be circular or have a shape conforming to the shape of the tubular pin. Any opening that has a portion slightly larger than the tubular pin to allow a quick expansion of the tubular pin is within the meaning of the “enlarged opening.”

For example, referring to FIG. 38, the slot may be shaped differently than that shown in FIG. 37. A click sound can be generated if the slot has a narrowed passage 200, 202, 204, 206, 208 smaller than the outside diameter of the tubular pin and an enlarged opening 210, 212, 214, 216, 218 slightly larger than the outside diameter of the tubular pin. The tubular pin is compressed and deformed as it passes through the narrowed passage 200, 202, 204, 206, 208. The enlarged opening 210, 212, 214, 216, 218 allows the tubular pin to quickly return to its originally non-compressed and non-deformed position when the tubular pin is received in the enlarged opening 210, 212, 214, 216, 218.

Referring back to FIG. 33 and FIG. 37, the lower housing 160 has a positioning feature for positioning the lower housing 160 relative to the adapting member 194. Due to the provision of the protective covers 168 for spoilers, the lower housing 160 should be oriented to make the first sides 171 of the protective covers 168 facing away the windshield to perform the wind deflection function. The adapting member 194 of FIG. 37 is shown to have a projection 220 provided at one side of the tubular pin 192. When the adapting member 194 is mounted to the lower housing 160, the lower housing 160 must be oriented to have the recess 178 at the same side as the projection 220. Therefore, the positioning feature that includes the recess 178 and the projection 220 ensures that the lower housing 160 is properly oriented to have the first sides 171 of the protective covers 168 facing the wind flow direction. The proper positioning of the lower housing 160 also ensures proper orientation of the spoilers.

### Seventh Embodiment

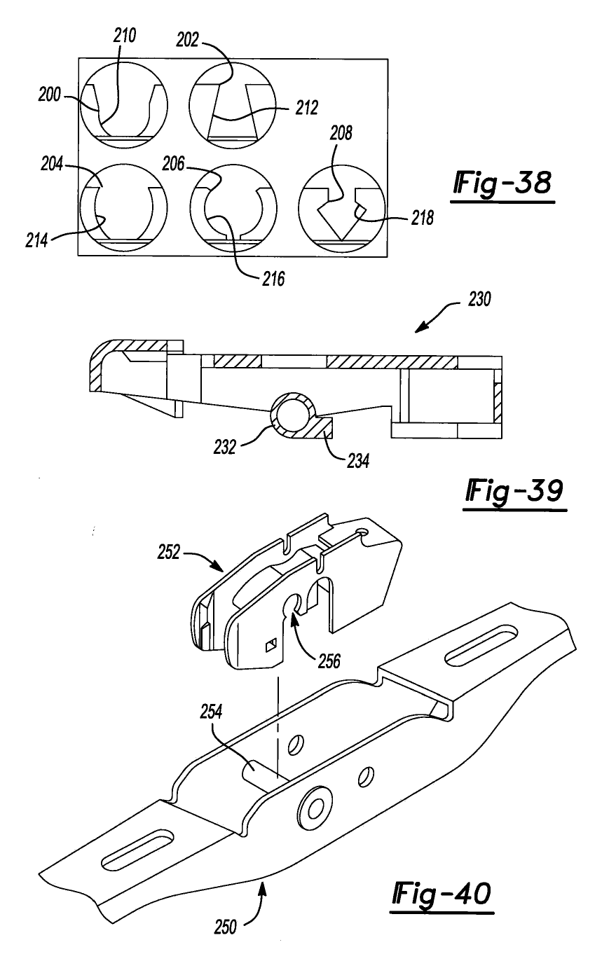

Referring to FIG. 39, an adapting member 230 is shown to have a structure similar to that described in the second embodiment except for a positioning feature. The adapting member 230 includes a tubular pin 232 to be inserted into the slot of the lower housing as shown in FIG. 33. A projection 234 is formed at one side of the tubular pin 232. FIG. 39 shows that the positioning feature previously described can be implemented in any of the adapting members in the embodiments previously described.

The different adaptor assemblies for different wiper arms in accordance with the teachings of the present disclosure can be mounted to the wiper blade by using a common bridge base and a common lower housing. To mount a specific type of wiper arm, only the adapting member adapted for the specific wiper arm needs to be changed. Therefore, the adaptor assemblies of the present disclosure allow for a quick connection between the wiper arm and the adaptor assemblies while reducing the costs of having to stock many different adaptor assemblies.

### Eighth Embodiment

Referring to FIG. 40, the sound verification feature described in connection with FIGS. 36 to 38 can be incorporated in other wiper blade components. For example, the sound verification feature can be incorporated in a wiper blade frame 250 and an adaptor 252. The wiper blade frame 250 includes a pin member 254. The adaptor 252 includes a slot portion 256. The adaptor 252 is mounted to the wiper blade frame 250 by inserting the pin member 254 into the slot portion 256. The structures of the wiper blade frame 250, the adaptor 252, and their engagement is described in U.S. Pat. No. 6,332,236, the disclosure of which is incorporated herein by reference in its entirety. The detailed description thereof is omitted for clarity.

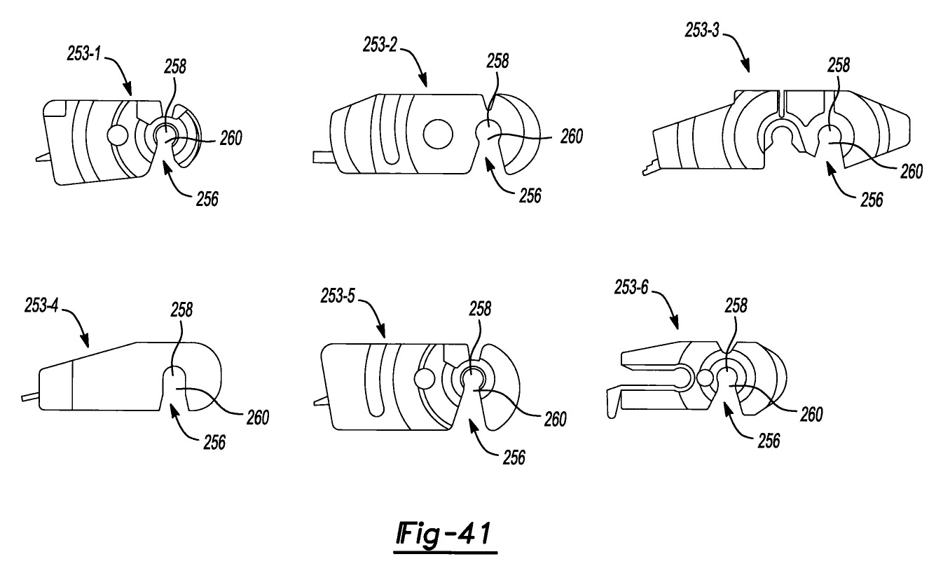

Referring to FIG. 41, the adaptor for the wiper blade frame 250 may have a variety of forms 253-1, 253-2, 253-3, 253-4, 253-5, 253-6 depending on the structures of the wiper blade frame 250 and the wiper arms to be mounted to the adaptor. The adaptors 253-1, 253-2, 253-3, 253-4, 253-5, 253-6 each include a slot portion 256. The slot portion 256 defines a circular opening 258 and a narrowed passage 260. The pin member 254 may have a structure similar to that of the tubular pin 192 of FIG. 37 and may include a thin-wall tubular body having an outside diameter slightly smaller than the inside diameter of a circular opening 258 and larger than the narrowed passage 260.

If the pin member 254 is made more flexible than the slot portion 256, the pin member 254 may be deformed when the pin member 254 is inserted into the slot portion 256. As the pin member 254 is inserted into the slot portion 254 and passes through the narrowed passage 260, the thin wall of the pin member 254 is compressed and deformed by the narrowed passage 260. When the pin member 254 is moved from the narrowed passage 260 to the circular opening 258 (which is an enlarged opening relative to the narrowed passage 260), the pin member 254, which is in a compressed and deformed state, quickly return to its original, non-compressed, non-deformed state due to material flexibility of the pin member 254. The quick movement of the pin member 254 results in the pin member 254 clashing against the circular surface that defines the circular opening 258 to generate an audible sound, for example, a click sound.

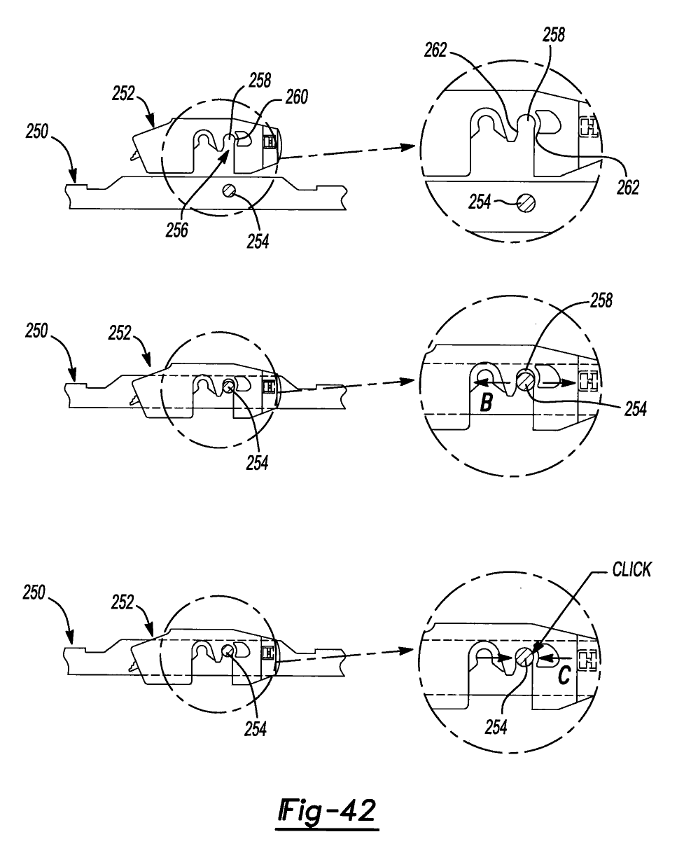

Alternatively, referring to FIG. 42, the pin member 254 may be a solid pin. The slot portion 256 may be made to be more flexible than the pin member 254 by using a more flexible material and by forming a thin-wall structure 262 at one or two sides of the narrowed passage 260. As the pin member 254 passes through the narrowed passage 260 of the slot portion 256, the thin-wall structure 262 adjacent to the narrowed passage 260 is deformed and/or moved away from the pin member 254, as indicated by arrows B. When the pin member 254 is moved from the narrowed passage 260 to the circular opening 258, the thin-wall structure 262 quickly returns to its original position, resulting in the thin-wall structure 262 clashing against the pin member 254 to generate an audible sound. The thin-wall structure 262 is properly configured and its material is properly selected so that the thin-wall structure 262 can quickly return to its original position to clash against the pin member 254 to generate the audible sound. The audible sound helps verify a complete connection between the adaptor and the wiper blade frame.

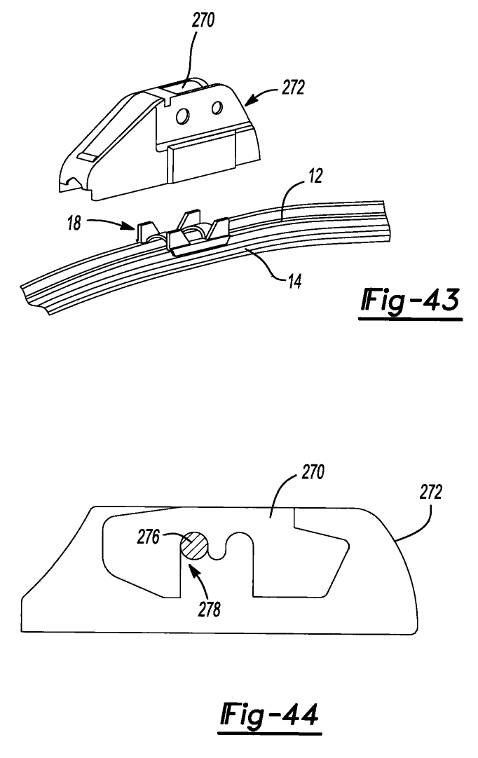

Referring to FIGS. 43 and 44, the sound verification feature can be used in connecting the adaptor 272 to an adaptor housing 274. The adaptor 272 has a structure similar to those shown in FIGS. 40-42 and is mounted in the adaptor housing 274 by inserting a pin member 276 of the housing 272 into the slot portion 278 of the adaptor 270.

It is understood and appreciated that the sound verification feature is not limited to the embodiments described herein and is not limited to a pin-and-slot arrangement. The sound verification feature can be applied to engagement between any two wiper blade components, including but not limited to, an adaptor, a wiper arm, an adaptor housing, a bridge base, a wiper blade support element, a wiper blade frame. Connecting two wiper blade components with the sound verification feature can be achieved by properly selecting the materials of the two components and by properly configuring the engaging members of the two wiper blade components. The engaging member of one of the wiper blade components is deformed or deflected during engaging process and is allowed to “quickly” return to its non-deformed, non-deflected state to clash against the engaging member of the other one of the wiper blade components. The sound verification feature facilitates assembling of the wiper blade components.

This description is merely exemplary in nature and, thus, variations that do not depart from the gist of the disclosure are intended to be included within the scope of the disclosure. Further areas of applicability of the present invention will become apparent from the detailed description provided hereinafter. It should be understood that the description and specific examples, while indicating the preferred embodiments of the invention, are intended for purposes of illustration only and are not intended to limit the scope of this disclosure.

What is claimed is:

1. An adaptor assembly kit for connecting a wiper arm to a wiper blade comprising:
a housing that is removably mounted to the wiper blade; and
a plurality of uniquely structured adapting members which are removably and interchangeably mounted to the housing, and which engage a wiper arm,
whereby, depending on a structure of the wiper arm, an adapting member designed to accommodate the structure of the wiper arm is selected from the plurality of adapting members, is mounted to the housing, and is coupled to the wiper arm.

2. The adaptor assembly kit of claim 1 wherein the wiper arm includes a circular pin and an L-shaped flat pin extending laterally from the wiper arm.

3. The adaptor assembly kit of claim 2 further comprising a cover pivotably mounted to one of the adapting members for securing the wiper arm to the one of the adapting members.

4. The adaptor assembly kit of claim 3 wherein the one of the adapting members includes a planar surface on which the L-shaped flat pin is disposed.

5. The adaptor assembly kit of claim 3 wherein the one of the adapting members defines a pin hole for receiving the circular pin of the wiper arm.

6. The adaptor assembly kit of claim 1 wherein the wiper arm has a U-shaped front end that includes a pair of side walls, a top wall, and a protrusion at an edge of the top wall.

7. The adaptor assembly kit of claim 6 wherein one of the adapting members includes a pair of deflectable fingers for engaging the wiper arm.

8. The adaptor assembly kit of claim 7 wherein the one of the adapting members further includes a front end and a rear end, the pair of deflectable fingers provided at the rear end, the side walls of the wiper arm disposed between the front end and the deflectable fingers.

9. The adaptor assembly kit of claim 1 wherein one of the wiper arms has a U-shaped front end that includes a pair of side walls, a top wall, a flat edge on the top wall, and an opening in the top wall.

10. The adaptor assembly kit of claim 9 wherein one of the adapting members includes a shoulder for engaging the flat edge of the wiper arm.

11. The adaptor assembly kit of claim 10 wherein the one of the adapting members includes a deflectable arm and a protrusion formed at the deflectable arm, the deflectable arm biased against the top wall and the protrusion inserted into the opening of the wiper arm.

12. The adaptor assembly kit of claim 1 wherein the plurality of adapting members are mounted to the housing in a snap-on relationship.

13. The adaptor assembly kit of claim 1 wherein the housing defines a slot and the plurality of adapting members each include a pin adapted to be inserted into the slot.

14. The adaptor assembly kit of claim 13 further comprising a pair of deflectable arms in the slot, wherein the pin is inserted between the pair of the deflectable arms.

15. The adaptor assembly kit of claim 1 wherein the housing includes a U-shaped base mounted on the wiper blade and a flange extending perpendicularly from the U-shaped base for engaging the adapting members.

16. The adaptor assembly kit of claim 15 wherein the adapting members each define a receiving space and a pin across the receiving space.

17. The adaptor assembly kit of claim 16 wherein the flange is received in the receiving space.

18. The adaptor assembly kit of claim 16 wherein the flange defines a slot for receiving the pin.

19. The adaptor assembly kit of claim 15 wherein the flange includes a pair of pins extending in opposite directions and the plurality of adapting members each define a pair of slots for receiving the pins.

20. A wiper blade assembly comprising:
a support element;
a rubber strip attached to the support element;
a bridge base secured to the support element;
a housing removably mounted to the bridge base in a snap-on relationship; and
a plurality of interchangeable adapting members removably mounted to the housing, each of the adapting members having a different structure for engaging wiper arms of different configurations.

21. The wiper blade assembly of claim 20 wherein the housing includes a U-shaped base and a flange extending perpendicularly from the U-shaped base.

22. The wipe blade assembly of claim 21 wherein the bridge base is received in the U-shaped base.

23. The wiper blade assembly of claim 21 wherein the plurality of adapting members each define a space for receiving the flange therein.

24. An adaptor assembly for connecting a wiper arm to a wiper blade comprising:
a housing that is removably mounted to the wiper blade; and
an adapting member removably mounted to the housing for engaging the wiper arm and including a top surface; and
a cover that is pivotably mounted to the adapting member for securing the wiper arm to the adapting member.

25. The adaptor assembly of claim 24 wherein the cover and the top surface of the adapting member defines a receiving space therebetween for receiving a portion of the wiper arm.

26. The adaptor assembly of claim 24 wherein the top surface is substantially planar.

27. The adaptor assembly of claim 24 wherein the cover has a substantially U-shaped structure.

28. The adaptor assembly of claim 27 wherein the adapting member is received inside the cover.

29. The adaptor assembly of claim 28 further comprising a locking member for locking the cover to the adapting member.

30. The adaptor assembly of claim 29 wherein the locking member includes a protrusion and a recess.

31. The adaptor assembly of claim 30 wherein the protrusion is formed at the cover and the recess is formed at the adapting member.

32. The adaptor assembly of claim 24 wherein the adapting member has a substantially plate configuration.

33. An adaptor assembly for connecting a wiper arm to a wiper blade comprising:
a housing removably mounted on the wiper blade;
an adapting member removably mounted on the housing for engaging the wiper arm, the adapting member including a front end, a rear end and a pair of deflectable fingers at the rear end,
wherein the wiper arm is secured to the adapting member by the deflectable fingers.

34. The adaptor assembly of claim 33 wherein the deflectable fingers are deflected by the wiper arm away from the front end when the wiper arm is mounted.

35. The adaptor assembly of claim 33 wherein the wiper arm includes a substantially U-shaped housing disposed between the front end and the deflectable fingers of the adapting member.

36. The adaptor assembly of claim 33 further comprising a pair of ear portions provided along a direction transverse of a longitudinal direction of the adapting member.

37. The adaptor assembly of claim 36 wherein the pair of ear portions define a pair of slots in which the deflectable fingers are disposed.

38. The adaptor assembly of claim 37 wherein the wiper arm includes a pair of side walls inserted in the pair of slots.

39. The adaptor assembly of claim 38 wherein the deflectable fingers are biased against the side walls of the wiper arm when the wiper arm is assembled.

40. An adaptor assembly for connecting a wiper arm to a wiper blade comprising:
a housing removably mounted to a wiper blade; and
an adapting member removably mounted to the housing for engaging the wiper arm, the adapting member including a shoulder for engaging a flat edge of the wiper arm and a deflectable arm that is biased against the wiper arm when the wiper arm is assembled to the adapting member.

41. The adaptor assembly of claim 40 wherein the deflectable arm includes a protrusion inserted into an opening of the wiper arm.

42. The adaptor assembly of claim 40 wherein the deflectable arm is formed on a top surface of the adapting member.

43. The adaptor assembly of claim 40 wherein the wiper arm includes a substantially U-shaped housing including a top wall, wherein the deflectable arm is biased against the top wall during assembly.

44. The adaptor assembly of claim 43 wherein the adapting member is received in the U-shaped housing of the wiper arm.

45. An adaptor assembly for connecting a wiper arm to a wiper blade comprising:
a housing mounted on the wiper blade; and
an adapting member removably mounted on the housing for engaging the wiper arm,
wherein when the adapting member is mounted to the housing, a sound is generated to verify a complete connection between the adapting member and the housing.

46. The adaptor assembly of claim 45, wherein the housing includes a slot portion, the adapting member including a tubular element received in the slot portion, the tubular element having an outside diameter, and
wherein the slot portion defines a narrowed passage and an enlarged opening, the narrowed passage being smaller than the outside diameter of the tubular element, the enlarged opening having a portion larger than the outside diameter of the tubular element.

47. The adaptor assembly of claim 46 wherein the tubular element is flexible.

48. The adaptor assembly of claim 46 wherein the tubular element is compressed and deformed as it passes through the narrowed passage and returns to its original position when the tubular element reaches the enlarged opening.

49. The adaptor assembly of claim 48 wherein the enlarged opening is defined by a surface of the slot portion, the tubular element clashing against the surface when the tubular element is received in the enlarged opening.

50. The adaptor assembly of claim 48 wherein the tubular element has a thin-walled structure.

51. The adapter assembly of claim 46 wherein the enlarged opening is a circular opening having an inside diameter larger than the outside diameter of the tubular element.

52. An adaptor assembly for connecting a wiper arm to a wiper blade comprising:
an adapting member for engaging the wiper arm and including a pin and a first positioning feature;
a U-shaped base removably mounted to the wiper blade;
a flange extending from the U-shaped base and including a slot portion and a second positioning feature,
wherein when the adapting member is mounted to the flange, the pin is inserted into the slot portion and the first positioning feature engages the second positioning feature.

53. The adaptor assembly of claim 52 wherein the first positioning feature includes a projection provided at one side of the pin and the second positioning feature includes a recess provided at one side of the slot portion.

54. The adaptor assembly of claim 53 wherein the recess is formed on a top surface of the flange.

55. The adaptor assembly of claim 52 further comprising a pair of protective cover provided at longitudinal ends of the U-shaped base, the protective cover having a profile conforming to a cross-sectional profile of spoilers.

56. An adaptor assembly for connecting a wiper arm to a wiper blade, the wiper blade including a support element and a spoiler provided on the support element comprising:
a U-shaped base removably mounted to the wiper blade;
a flange extending from the U-shaped base;
an adapting member for engaging the wiper arm and removably mounted to the flange; and
a protective cover provided at each longitudinal end of the U-shaped base for covering a portion of the spoiler.

57. The adaptor assembly of claim 56 wherein the protective cover secures the spoiler to the wiper blade.

58. The adaptor assembly of claim 56 wherein the protective cover has a profile conforming to a cross-sectional profile of the spoiler.

59. A wiper blade assembly comprising:
a first wiper blade component including a pin member; and
a second wiper blade component including a slot portion and removably mounted to the first wiper blade component;
wherein when the first wipe blade is mounted to the second wiper blade by inserting the pin member to the slot portion, a sound is generated to verify a complete connection between the first wiper blade component and the second wiper blade component.

60. The wiper blade assembly of claim 59, wherein the slot portion defines an enlarged opening and a narrowed passage, and the pin member is larger than the narrowed passage.

61. The adaptor assembly of claim 59 wherein one of the slot portion and the pin member is deformed when the pin member passes through the narrowed passage.

62. The adaptor assembly of claim 61 wherein the one of the slot portion and the pin member returns to its original position and clashes against a surface of the other one of the slot portion and the pin member when the pin member moves from the narrowed passage to the enlarged opening.
